(19) United States
(12) Patent Application Publication
(10) Pub. No.: US 2024/0375846 A1
(43) Pub. Date: Nov. 14, 2024

(54) INSULATING CONTAINER FOR A BEVERAGE HOLDER

(71) Applicant: ADNART INC., Montreal (CA)

(72) Inventor: Arie PISAREVSKY, Montreal (CA)

(21) Appl. No.: 18/286,150

(22) PCT Filed: Apr. 18, 2022
(86) PCT No.: PCT/IB2022/053602

§ 371 Date: Oct. 9, 2023

Related U.S. Application Data
(60) Provisional application No. 63/176,344, filed on Apr. 18, 2021.

(51) Int. Cl. B65D 81/38; B65D 47/28; B65D 51/26

(52) U.S. Cl. CPC B65D 81/3876; B65D 47/286; B65D 51/26

(57) ABSTRACT

Apparatuses and devices for insulating fluid holders are disclosed. An insulating container (100) is configured to insulate a fluid holder (108). The insulating container (100) comprises a lid (102) having an inner mechanism on an inner wall for coupling with a first portion of the fluid holder and a first coupling mechanism 114 to engage with a container (104) having a second coupling mechanism 116. The container is configured to accommodate a second portion of the fluid holder. The first coupling mechanism is configured to be engaged with the second coupling mechanism to insulate the fluid holder. The lid and the container are configured to accommodate the fluid holders of a plurality of sizes.

### FIELD OF THE INVENTION

The present invention relates to containers containing fluids such as beverages. More specifically, the present invention relates to insulated container apparatuses and devices.

### BACKGROUND OF THE INVENTION

There are different types of beverages which can be either available as readymade or may be prepared instantly. Such beverages such as tea, coffee, soda drinks, soft drinks, hard drinks whether hot or cold can be stored or packed in different containers such as sealed cans or bottles or cups.

Such containers have often tendency to lose hotness or coldness of the beverages when kept for some time after opening the containers stored therein. In addition, the containers containing hot beverages may get heated due to transfer of heat of the hot beverage to the walls of the containers, hence may be inconvenient for persons to hold such containers in hands thereof. In another scenario where the container contains cold beverage, the container may be too cold to hold the container. Further, water droplets may appear on the walls of the container. In such a scenario, people feel inconvenient to hold wet containers. In some instances, people may put tissue paper or handkerchief onto the wet containers. The tissue paper may absorb the water droplets, get tear and may stick there onto, which again causes inconvenience. The handkerchief may get wet.

In order to retain the temperature condition of a beverage can, an insulated device is normally placed around the beverage can so that the insulated device is able to insulate the beverage can from heat via both conduction and external infrared sources such as, a hand, warm air, or strong sunlight. There are many such conventional insulated containers or devices which can insulate the temperature of the beverage containers. For example, an insulating container may include a sealing ring around a lid thereof along with many assemblies. Engaging all the assemblies to secure the beverage cup is quite challenging. Many of the existing insulated devices only enclose the lateral wall and the base end of the beverage can, where the top end of the beverage can is opened to the surrounding environment. Since the top end of the beverage can is not covered, heat transfers through the top end of the beverage can, changing the temperature of the beverage within. Additionally, the insulated devices expose the beverage within the beverage can to outside elements, such as insects and dust as the opening of the beverage can is not covered. Moreover, some insulating container cans hold the beverage container specific to particular dimensions of the containers.

Therefore, there exists a need for alternate insulated containers which can accommodate the beverage containers of different configurations.

### SUMMARY OF THE EMBODIMENTS

It is therefore an object of the invention to provide an insulating device for insulating a holder/container containing beverages.

According to one aspect of the presently disclosed subject matter, there is provided an insulating container for insulating a fluid holder containing a fluid. The insulating container comprising a lid 102 comprising an inner mechanism on an inner wall for coupling with a first portion of the fluid holder and a first coupling mechanism 114. The insulating container further comprising a container 104 configured to accommodate a second portion of the fluid holder and comprising a second coupling mechanism 116. As appropriate, the first coupling mechanism is configured to be engaged with the second coupling mechanism to insulate the fluid holder.

As appropriate, the first coupling mechanism is engaged with the second coupling mechanism to form a male-female connector.

As appropriate, the lid and the container are configured to accommodate the fluid holders of a plurality of sizes.

As appropriate, the plurality of sizes comprises radius of the fluid holder.

As appropriate, the inner mechanism of the lid comprising a gripping ring subsided therein to hold the first portion of the fluid holder.

As appropriate, the first coupling mechanism of the lid is provided on an outer wall of the lid.

As appropriate, the second coupling mechanism of the container is provided on an inner wall of the container.

As appropriate, the first coupling mechanism of the lid is provided on a lower periphery of the lid.

As appropriate, the second coupling mechanism of the container is provided on an upper periphery of the container.

As appropriate, the diameter of the inner wall of the lid is greater than the first portion of the fluid holder and inner mechanism of the lid snugly fits the first portion of the fluid holder.

As appropriate, the fluid is either cold or hot as compared to the fluid holder and wherein the heat transfer takes place to or from the fluid, respectively.

As appropriate, the container is constructed from a hard material selected from a group consisting of one or more of metals, alloys, polypropylene, and/or combinations thereof.

As appropriate, the lid is constructed from a soft flexible material selected from a group consisting of one or more of polymer, rubber, silicone, and/or combinations thereof.

As appropriate, the first coupling mechanism comprises a first screw thread and the second coupling mechanism comprises a second screw thread configured to engage with the first screw thread when the lid is turned in a clockwise direction about the container.

As appropriate, the first coupling mechanism comprises a first pattern embossed on an outer wall of the lid and the second coupling mechanism comprises a second pattern engraved within the inner wall of the container, wherein the first pattern and the second pattern form a male-female connector, respectively.

As appropriate, a space is provided between an inner wall and an outer wall of the lid forming a pocket sleeve for accommodating the wall of the container, wherein the container snugly fits within the pocket sleeve.

As appropriate, the lid comprises an inner wall, an outer wall and a third pattern on the surface between the inner and the outer wall.

As appropriate, the container comprises a fourth pattern on the surface between an inner wall and an outer wall.

As appropriate, the third pattern and the fourth pattern form a male-female connector, respectively.

As appropriate, the lid comprises a slidable switch to expose the fluid holder.

According to another aspect of the presently disclosed subject matter, there is provided an insulating container apparatus for insulating a fluid holder containing a fluid. The insulating container apparatus comprising a fluid holder having an upper portion of a first size and a lower portion of a second size. The insulating container apparatus further comprising a lid comprising an inner mechanism on an inner wall for coupling with the upper portion of the fluid holder and a first coupling mechanism. The insulating container apparatus also comprising a container configured to accommodate the lower portion of the fluid holder and comprising a second coupling mechanism. As appropriate, the first coupling mechanism is configured to be engaged with the second coupling mechanism to insulate the fluid holder.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice.

As used in this specification, the singular indefinite articles “a”, “an”, and the definite article “the” should be considered to include or otherwise cover both single and plural referents unless the content clearly dictates otherwise. In other words, these articles are applicable to one or more referents. As used in this specification, the term “or” is generally employed to include or otherwise cover “and/or” unless the content clearly dictates otherwise.

In the accompanying drawings:

FIG. 1 illustrates a front perspective view of an insulating container 100;

FIG. 2 illustrates another front prospective view of the insulating container 100;

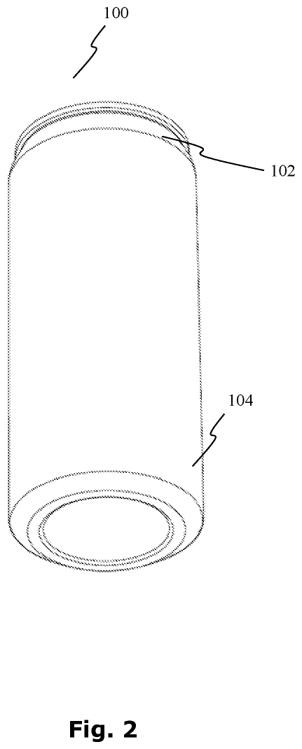

FIG. 3 illustrates yet another front prospective view of the insulating container 100;

FIG. 4 illustrates an exploded view of the insulating container 100 for insulating a beverage holder 108;

FIG. 5 illustrates an exploded view of an engagement of the lid 102 with the beverage holder 108;

FIG. 6 illustrates a perspective view of the insulated container 100 with the lid engaged on the top of the beverage holder;

FIG. 7 illustrates a front view of the sealed insulated container 100;

FIG. 8 illustrates another view of the sealed insulated container 100 with the beverage holder and a straw 112;

FIG. 9 illustrates an exploded view of another insulating container 200 with a different sized beverage holder 208;

FIGS. 10A and 10B illustrate top view of the insulating container 100 and the lid 102, respectively;

FIGS. 11A and 11B illustrate top view of the lid 102 on the container 104 with the closed lid and the opened lid, respectively;

FIG. 12 illustrates another embodiment of engagement of the insulating container 300; and

FIG. 13 illustrates another embodiment of the insulating container 400.

### DESCRIPTION OF THE SELECTED EMBODIMENTS

Reference will now be made in detail to the preferred embodiments of the present invention, examples of which are illustrated in the accompanying drawings.

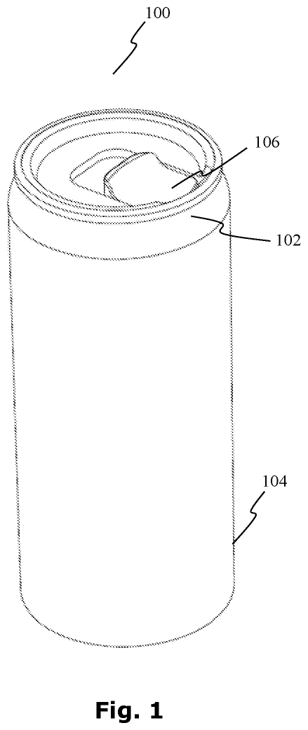

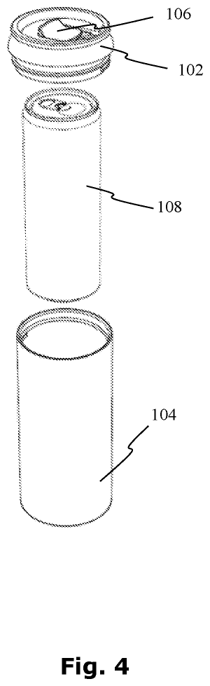

FIG. 1 illustrates an insulating container 100 for insulating a beverage holder (not shown in FIG. 1) containing beverages. The beverage holder can be a can, glass, covered glass, a tumbler, a flask, a cup, a bottle, an expandable container and the like. The insulating container 100 includes a lid 102 and a container 104. The insulating container 100 is configured to insulate the beverage holder 108 as shown in FIG. 4.

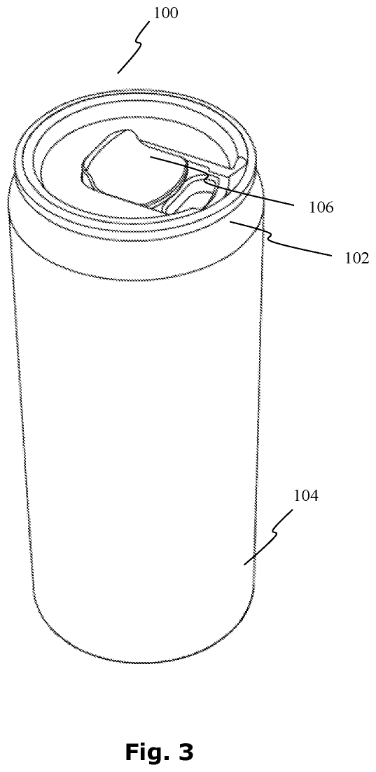

The lid 102 is configured to have an arrangement to expose the beverage holder 108 in an open configuration and seal the beverage holder 108 in a closed configuration. Such an arrangement may be achieved by having different mechanisms involved in the lid 102. In some aspects, the lid 102 includes a slidable switch 106 which can be configured to slide to open and close the lid 102 as shown in FIG. 1. In some embodiments, the lid 102 includes a substantial portion, preferably half circular portion may be lifted up to expose a half view of the beverage holder 108 as shown in FIG. 3. Thus, such mechanisms enable exposure of the beverage holder 108 when accommodated in the insulating container 100 in an open configuration and seal thereof in a closed configuration.

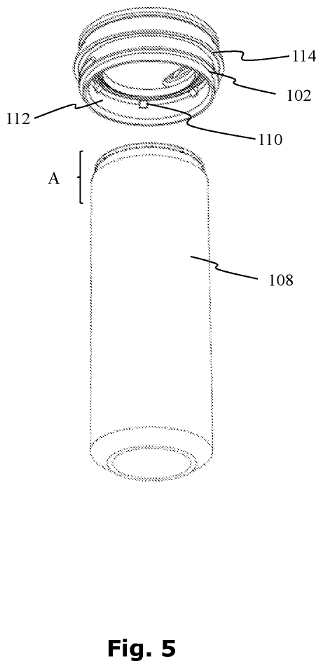

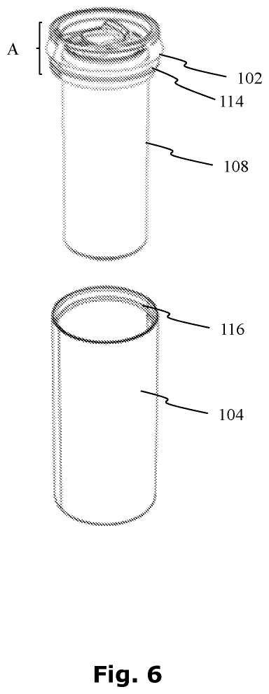

FIG. 4 illustrates a perspective view of the insulating container 100 with the lid 102 and the container 104, both configured to engage with the beverage holder 108. The lid 200 is configured to comprise a mechanism to engage with an upper part of the beverage holder 108. The lid 102 comprises a gripping ring 110 on an inner wall 112 to hold the first portion A of the beverage holder 108 as shown in FIG. 5. The gripping ring 110 may be engaged with the first portion A of the beverage holder 108 to form a male and female connector as shown in FIG. 6. According to an embodiment of the present invention, the lid 102 may first be introduced onto the first portion A of the beverage holder 108. The gripping ring 110 may produce a vacuum therein and a suction to hold the beverage holder 108.

In some aspects, the inner mechanism of the lid 102 comprises a snugly fit of the first portion A of the beverage holder 108 into the lid 102. In such an aspect, the lid 102 has a larger diameter as compared to that of the first portion A of the beverage holder 108 and holds the beverage holder 108 without requiring the gripping ring 110.

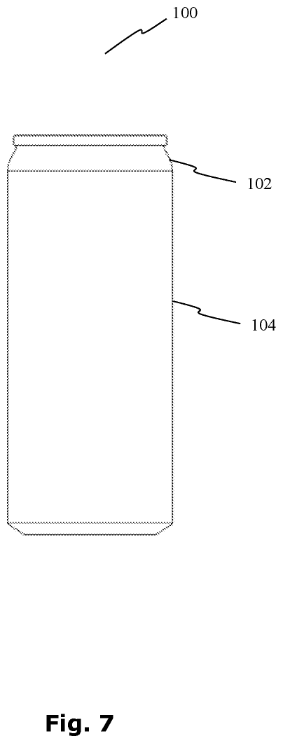

Referring to FIG. 6, the outer mechanism of the lid 102 includes an outer wall having a first coupling mechanism 114 which is configured to engage with and an inner wall of the container 104 having a second coupling mechanism 116. In some aspects, the first coupling mechanism 114 comprises a first screw thread and the second coupling mechanism 116 comprises a second screw thread configured to engage with the first screw thread to form a male-female connector when the lid 102 is turned in a clockwise direction about the container 104. The screw threads may be configured such that they cover the entire circumference of the lid 102 and similar screw threads covering entire circumference of the container 104. FIG. 7 illustrates a front view of the insulating container 100 containing the beverage holder 108 (not visible) within the lid 102 and the container 104.

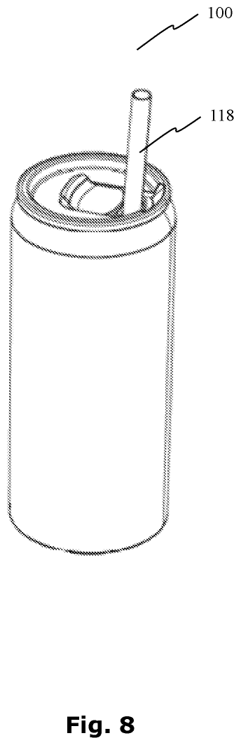

The beverage holder 108 may also include an opening for a straw 118 as shown in FIG. 8. The straw 118 may be detachable. In some aspects, the straw 118 may be compressible such that a substantial portion of the lid 102 opens to expose the straw 118 and the beverage holder 108. On other hand, when the substantial portion of the lid 102 closes, the straw 118 may be compressed.

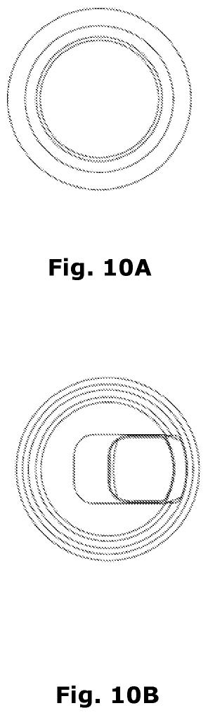

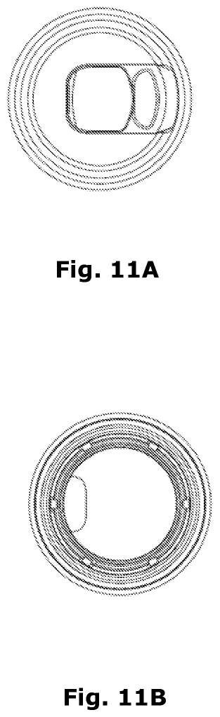

FIGS. 10A and 10B illustrate top view of the insulating container 100 and the lid 102, respectively. FIG. 11A illustrates a top view of the sealed insulated container 100 with the beverage holder 108 inside and the closed lid 102. FIG. 11B illustrates a top view of the sealed insulated container 100 with the beverage holder 108 inside and the opened lid 102.

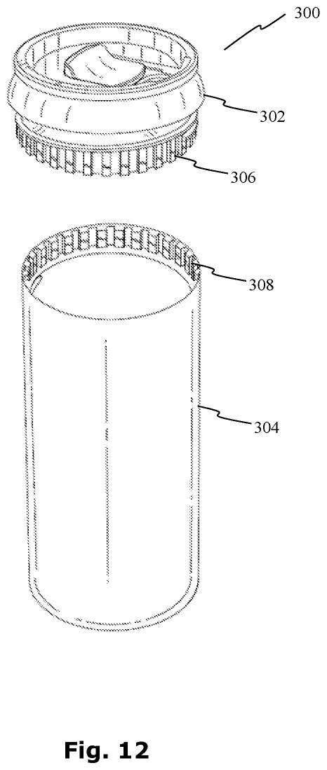

FIG. 12 illustrates another embodiment of engagement mechanism of the insulating container 300. The lid 302 comprises a first coupling mechanism 306 with a first pattern engraved on the outer wall of the lid 302. The container 304 comprises a second coupling mechanism 308 with a second pattern embossed on the inner wall of the container 304. The second pattern and the first pattern may form a male-female connector, respectively.

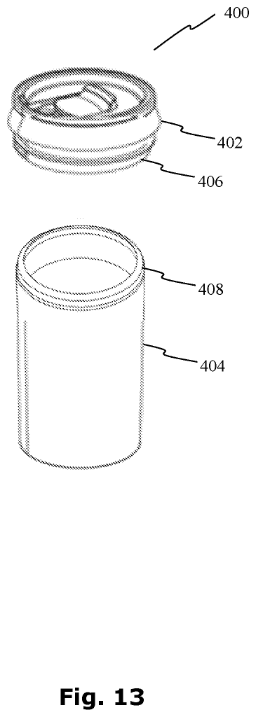

FIG. 13 illustrates another embodiment of engagement mechanism of the insulating container 400 with a different engagement mechanism between the lid 402 and the container 404.

It should be noted that the engagement mechanisms disclosed above exemplary in nature and should not limit the scope of the invention. The engagement mechanism may include other such patterns, not limited to, slits of any shape such as rectangular, triangular, circular, and so on.

Alternatively, the lid 102 and the container 108 may have the engagement mechanism as patterns on the lower surface and the upper surface, respectively, to engage as the male-female connector. The pattern of the sleeve lid 102 may be configured to interlock with the pattern of the container 108 such that the two patterns snap-fit into each other. Examples of the patterns may include such as but are not limited to an irregular matrix, slits, and any shape-oriented modules configured for connecting, and so on.

The beverage may include such as but not limited to tea, coffee, soft drinks, soda drinks, and so on. The beverage is either cold or hot as compared to the beverage container and wherein the heat transfer takes place to or from the beverage, respectively. The insulation mechanism of the insulating container 100 may be configured to prevent heat transfer to the hands of the user from a hot liquid within the beverage holder 108 or vice-versa for a hot liquid.

In the preferred embodiments, the lid 102 may be made up of soft flexible materials selected from a group consisting of one or more of polymer, rubber, silicone, and/or combinations thereof. The container 104 may be constructed from a hard material selected from a group consisting of one or more of metals, alloys, polypropylene, and/or combinations thereof. Either of the lid or container or both may be single walled. However, in some aspects, the lid or container or both may be double walled.

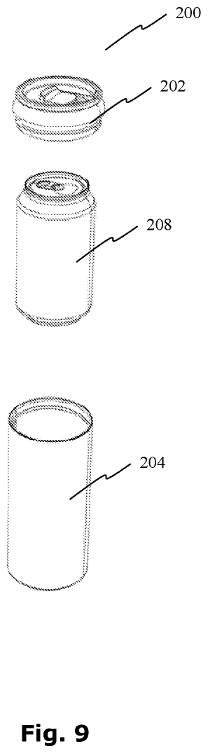

The beverage holder 108 to be insulated by the insulating container 100 may be of different sizes. The size may be defined as radius of the upper and lower part of the beverage holder 108. The container 104 of the insulating container 100 may be configured to hold the beverage holder 108 of any size as shown in FIGS. 4 and 9 respectively. The flexible material of the lid 102 may also allow different sized beverage holders 108 to be engaged with the lid 102.

While the preferred embodiment of the present invention and its advantages has been disclosed in the above detailed description, the invention is not limited there to but only by the scope of the appended claim.

As will be readily apparent to those skilled in the art, the present invention may easily be produced in other specific forms without departing from its essential characteristics. The present embodiments are, therefore, to be considered as merely illustrative and not restrictive, the scope of the invention being indicated by the claims rather than the foregoing description, and all changes which come within therefore intended to be embraced therein.

1. An insulating container 100 for insulating a fluid holder 108 containing a fluid, the insulating container 100 comprising:
a lid 102 comprising an inner mechanism on an inner wall for coupling with a first portion of the fluid holder and a first coupling mechanism 114; and
a container 104 configured to accommodate a second portion of the fluid holder and comprising a second coupling mechanism 116;
wherein, the first coupling mechanism is configured to be engaged with the second coupling mechanism to insulate the fluid holder.

2. The insulating container of claim 1, wherein the first coupling mechanism is engaged with the second coupling mechanism to form a male-female connector.

3. The insulating container of claim 1, wherein the lid and the container are configured to accommodate the fluid holders of a plurality of sizes.

4. The insulating container of claim 3, wherein the plurality of sizes comprises radius of the fluid holder.

5. The insulating container of claim 1, wherein the inner mechanism of the lid comprising a gripping ring subsided therein to hold the first portion of the fluid holder.

6. The insulating container of claim 1, wherein the first coupling mechanism of the lid is provided on an outer wall of the lid.

7. The insulating container of claim 1, wherein the second coupling mechanism of the container is provided on an inner wall of the container.

8. The insulating container of claim 1, wherein the first coupling mechanism of the lid is provided on a lower periphery of the lid.

9. The insulating container of claim 1, wherein the second coupling mechanism of the container is provided on an upper periphery of the container.

10. The insulating container of claim 1, wherein the diameter of the inner wall of the lid is greater than the first portion of the fluid holder and inner mechanism of the lid snugly fits the first portion of the fluid holder.

11. The insulating container of claim 1, wherein the fluid is either cold or hot as compared to the fluid holder and wherein the heat transfer takes place to or from the fluid, respectively.

12. The insulating container of claim 1, wherein the container is constructed from a hard material selected from a group consisting of one or more of metals, alloys, polypropylene, and/or combinations thereof.

13. The insulating container of claim 1, wherein the lid is constructed from a soft flexible material selected from a group consisting of one or more of polymer, rubber, silicone, and/or combinations thereof.

14. The insulating container of claim 1, wherein the first coupling mechanism comprises a first screw thread and the second coupling mechanism comprises a second screw thread configured to engage with the first screw thread when the lid is turned in a clockwise direction about the container.

15. The insulating container of claim 1, wherein the first coupling mechanism comprises a first pattern embossed on an outer wall of the lid and the second coupling mechanism comprises a second pattern engraved within the inner wall of the container, wherein the first pattern and the second pattern form a male-female connector, respectively.

16. The insulating container of claim 1, wherein a space is provided between an inner wall and an outer wall of the lid forming a pocket sleeve for accommodating the wall of the container, wherein the container snugly fits within the pocket sleeve.

17. The insulating container of claim 1, wherein the lid comprises an inner wall, an outer wall and a third pattern on the surface between the inner and the outer wall.

18. The insulating container of claim 17, wherein the container comprises a fourth pattern on the surface between an inner wall and an outer wall.

19. The insulating container of claim 18, wherein the third pattern and the fourth pattern form a male-female connector, respectively.

20. The insulating container of claim 1, wherein the lid comprises a slidable switch to expose the fluid holder.

21-41. (canceled)
